(19) United States
(12) Patent Application Publication
(10) Pub. No.: US 2026/0027395 A1
(43) Pub. Date: Jan. 29, 2026

(54) FLAME MITIGATION DEVICE FOR FUEL CONTAINER

(71) Applicant: SCEPTER US HOLDING COMPANY, Akron, OH (US)

(72) Inventors: Sergio O. GARZA, Bella Vista, AR (US); Kristopher C. SNYDER, Claremore, OK (US); Joseph Frank CLEAR, III, Cincinnati, OH (US); Geoffrey Allen KING, Mt. Sterling, OH (US)

(21) Appl. No.: 18/998,291

(22) PCT Filed: Jul. 27, 2023
(86) PCT No.: PCT/US2023/028768

§ 371 Date: Jan. 24, 2025

Related U.S. Application Data
(60) Provisional application No. 63/369,564, filed on Jul. 27, 2022.

(51) Int. Cl. A62C 3/06; A62C 4/00

(52) U.S. Cl. CPC A62C 3/065; A62C 4/00

(57) ABSTRACT

A flame mitigation device (FMD) for use within a portable fuel container includes a substantially rigid body extending along a center axis and having a plurality of perforations configured to provide fluid communication therethrough. The body further includes a split end comprising at least two prongs that have interior facing prong sidewalls diverging at an angle.

### CROSS-REFERENCE TO RELATED APPLICATIONS

This application claims priority to and the benefit of pending U.S. Provisional Application No. 63/369,564, filed Jul. 27, 2022, which is incorporated by reference herein in its entirety.

### BACKGROUND

The present disclosure relates to a flame mitigation device/flame arrestors for portable containers, and fuel container assemblies incorporating the same. The flame mitigation devices have particular application with portable fuel containers and will be described with particular reference thereto. However, it is to be appreciated that the present exemplary embodiments are also amenable to other like applications.

Consumer portable fuel containers (CPFCs) are well known in the art. They are used to transport, store and dispense diesel fuel and gasoline. Consumers utilize the CPFCs in connection with a fuel tank typically associated with an internal combustion engine such as a lawnmower, chain saw, snowmobile, power generator or the like. As used herein, the term, portable fuel container refers to a container that can be carried by the consumer. Such portable fuel containers have traditionally been constructed of metal or synthetic resin.

A flame mitigation device (“FMD”) is a safety device intended to reduce the chance of some types of fires and explosions within portable fuel storage containers, among other things. In theory, an FMD functions by absorbing the heat from a flame front traveling at subsonic velocities, thus dropping the burning gas/air mixture below its auto-ignition temperature; consequently, the flame cannot survive. FMDs can reduce the chances the flashback explosions which occur when vapor escaping the container contacts a flame or a spark. The vapor can ignite and “flash back” inside the container.

Current FMDs for use with portable fuel containers include a plurality of small holes/openings/perforations each of substantially uniform size. Generally, the perforations are sized to present an open area of not more than about 0.04 inches (1.0 mm) by 0.04 inches (1.0 mm). The flow of fluid therethrough is dependent on both the number of perforations and size of those perforations. Consumers desire durable flame arrestors that are effective in suppressing flames while presenting no obstacles in their implementation and use.

The present disclosure provides certain improvements to FMDs.

### SUMMARY OF DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In accordance with one aspect of the present disclosure, a flame mitigation device is described. A flame mitigation device (FMD) for use within a portable fuel container includes a substantially rigid hollow body having a plurality of perforations, a first open end and a second closed end. The closed end including a “split” or forked portion. The split end includes at least two prongs that have interior facing prong sidewalls diverging at an angle. In a further embodiment, the flame mitigation device is configured to absorb enough heat to drop the burning air/fuel mixture below its autoignition temperature at a flame speed between 4-6 meters per second. In another further embodiment, the FMD further includes at least one perforation-less body portion defining an area along a length of the flame mitigation device. In another further embodiment, the FMD further includes one or more cantilevered retention members extending from an exterior sidewall of the body configured to prevent removal of the flame mitigation device from a portable fuel container. In another further embodiment, the perforations comprise perforations of a first size and perforations of a second size. In another further embodiment, the FMD further includes a substantially planar bottom end of each prong. In another further embodiment, the FMD further includes bottom perforations located on the substantially planar bottom end of each prong configured to provide fluid communication from the interior of the flame mitigation device to the exterior thereof. In another further embodiment, an open area of each perforation has a normal vector that is substantially parallel to a radius extending from a center axis of the body. In another further embodiment, an open area of each perforation has a normal vector that is substantially parallel to each other perforation. In another further embodiment, an interior surface of the FMD includes a surface texture. In another further embodiment, the surface texture is about 200 to about 500 microinches average roughness.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1A is a plan view illustration of an exemplary Flame Mitigation Device in accordance with the present disclosure.

FIG. 1B is a detailed view of the closed bottom end of the FMD of FIG. 1A.

FIG. 1C is a detailed view of the open top end of the FMD of FIG. 1A.

FIG. 1D is a bottom view of the FMD of FIG. 1A.

FIG. 1E is a perspective view of the FMD of FIG. 1A.

FIG. 1F is a cross-sectional view of the FMD of FIG. 1A taken along a plane bisecting the angle of the split end prongs.

FIG. 1G is a side view of the FMD of FIG. 1A illustrating the seam line for molding.

FIG. 1H is view of the FMD from the seam line of FIG. 1G.

FIG. 2A is a plan view illustration of another exemplary Flame Mitigation Device in accordance with the present disclosure.

FIG. 2B is a detailed view of the open top end of the FMD of FIG. 2A.

FIG. 2C is a detailed view of the closed bottom end of the FMD of FIG. 2A.

FIG. 2D is a perspective view of the FMD of FIG. 2A.

FIG. 3A is a perspective view of another FMD in accordance with the present disclosure.

FIG. 3B is a cross-sectional view of the FMD of FIG. 3A taken along a plane bisecting the angle of the split end prongs.

FIG. 4A is a side view of another FMD in accordance with the present disclosure.

FIG. 4B is a side view of a distal end of the FMD of FIG. 4A.

FIG. 4C a side view of the FMD of FIG. 4A when rotated ninety degrees about a central axis thereof.

FIG. 4D is a cross-sectional view of the FMD along section line H-H in FIG. 4C.

FIG. 4E illustrates a perspective view of the distal end of the FMD of FIGS. 4A and 4B.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure and are therefore not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

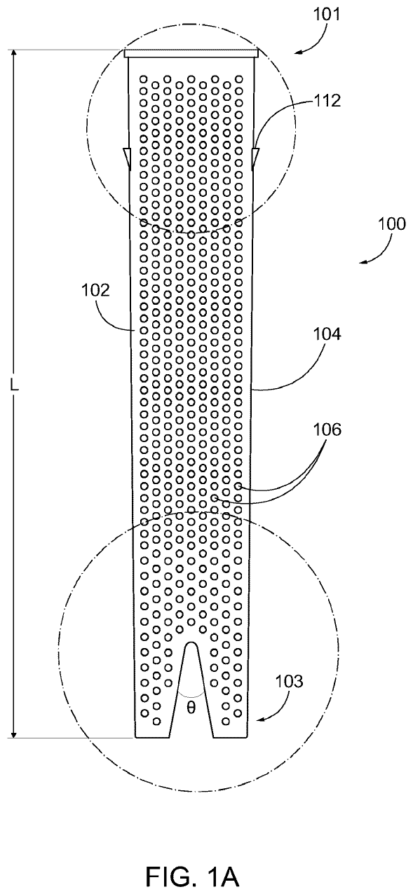

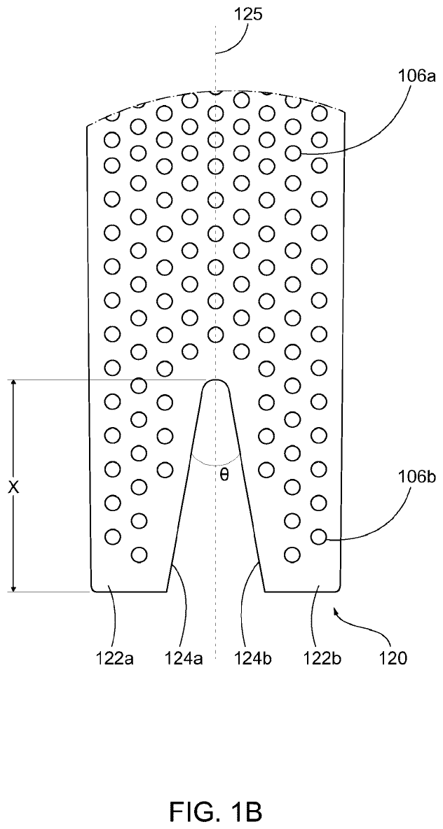

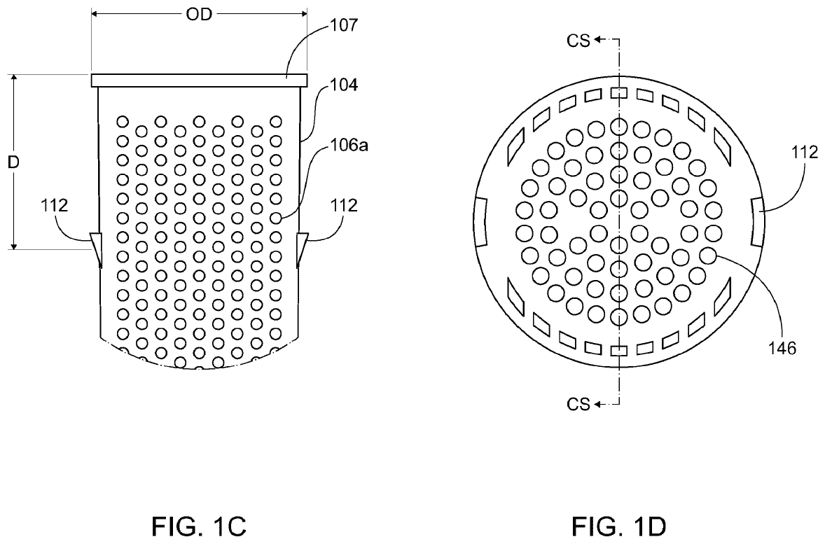

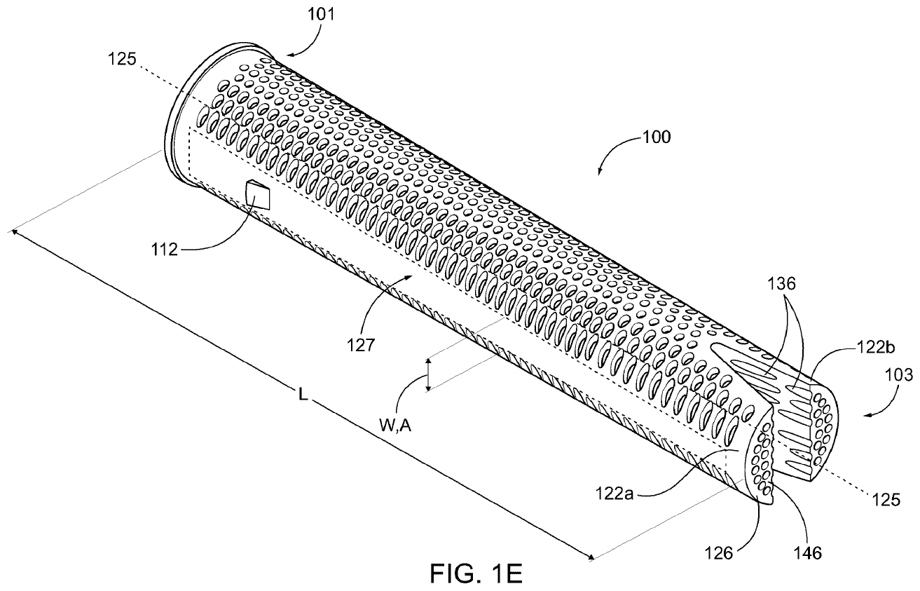

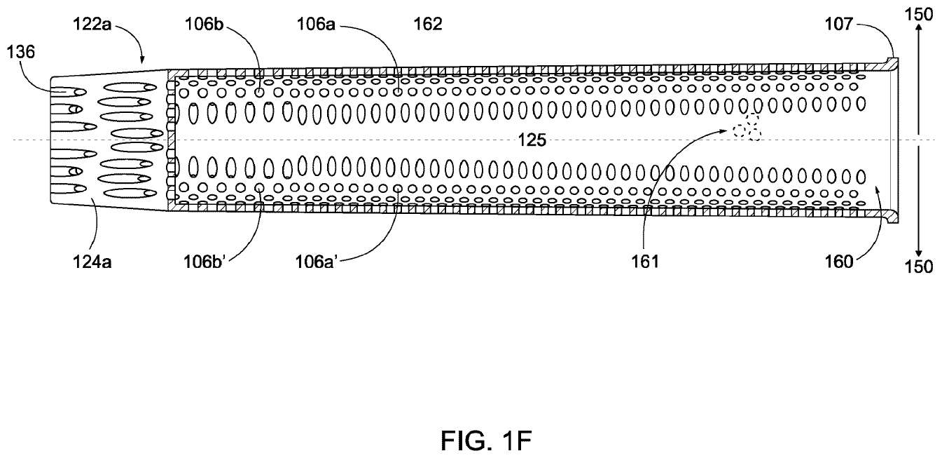

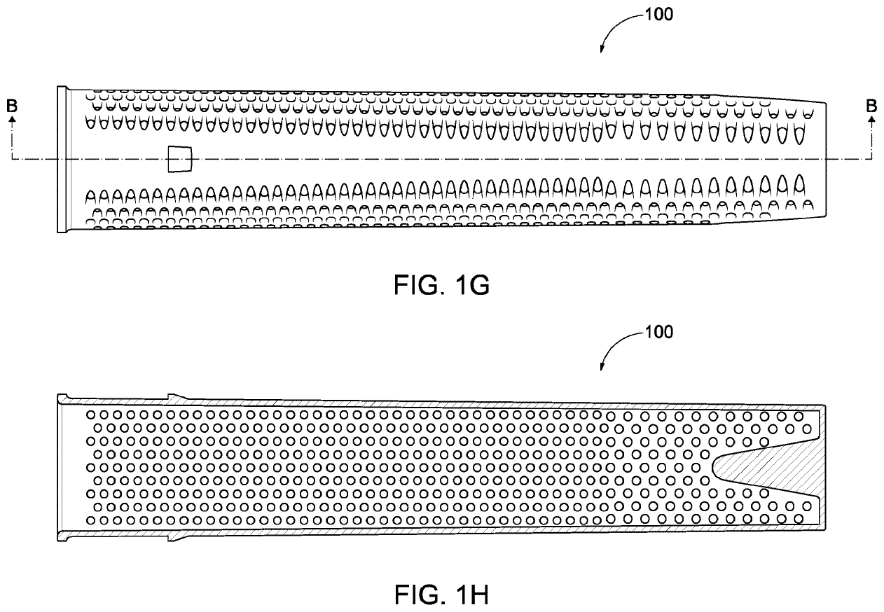

The present disclosure relates generally to flame mitigation device employing perforations and having a closed end that is split. Referring now to FIGS. 1A-1F, shown is an illustration of an exemplary flame mitigation device (“FMD”) 100 according to an embodiment of the disclosure. Those skilled in the art will recognize that a portable fuel container may be a variety of different fuel containers with which the FMD 100 may be employed.

The exemplary FMD 100 is used to mitigate spark and/or flame entering the interior of the hollow body of a fuel container. The FMD 100 is generally sized and shaped, i.e., “configured” so to be capable of being inserted into a neck of a portable fuel container. The FMD generally operates by absorbing the heat enough to drop the burning air/fuel mixture below its autoignition temperature at a flame speed between 4-6 meters per second.

The FMD 100 includes a body 102 that extends along a center axis 125 and is of length L that is measurable along the center axis 125, wherein the body 102 includes both an inner sidewall (not illustrated) defining an interior surface 160 and outer sidewall defining an outer surface 104 of the body 102, the general shape of which can be either cylindrical, semi-cylindrical, conical, cuboid, or the like. Those skilled in the art will recognize that triangular, square and multi-angle shapes such as hexagonal or octagonal are also possible. The body 102 is configured with a plurality of perforations 106 that allow fluid communication from the inner sidewall to the outer sidewall. That is, fluid flow is possible through the FMD 100 through the perforations 106.

In some embodiments, the body 102 is substantially cylindrical in shape. In some embodiments, the body 102 is tapered having an open top end 101 that is larger in diameter than a closed bottom end 103. The taper may be constant along the length L of the body 102 or may begin at a location along the body 102. In some exemplary embodiments, the body 102 has a taper from the top end 101 to the bottom end 103 from about 0.5 degree to about 5 degrees. In further embodiments, the body 102 has a taper from the top end 101 to the bottom end 103 from about 1.0 degree.

The FMD 100 may be made of any suitable material that does not degrade in the presence of volatile liquids, such as hydrocarbon-based fuels including but not limited to nylon, polyester, polyethylene, polypropylene or other synthetic resins compatible with the material the container body and resistant to chemicals. The FMD material may also be resistant to flames. In some embodiments, the FMD 100 is composed of a substantially rigid polymer material. The composition is such that the FMD 100 is able to hold its own shape. Per ASTM-F3326, the FMD material may be similar to the material of a corresponding fuel container body 101 and must pass all material testing requirements in ASTM-F852.

In some embodiments and as illustrated in the exemplary embodiments of FIGS. 1A-1F, a generally annular flange 107 FMD extends circumferentially around an upper end of the FMD 100. Those skilled in the art will recognize that the shape of the annular flange 107 is not limiting and other shapes of the flange are also within the scope of the invention. In some embodiments, the annular flange 107 holds the FMD 100 at predetermined position within the neck of a portable fuel container. The annular flange 107 surrounds an open area into which a fuel nozzle may be inserted. The annular flange 107 projects outwardly from the outer surface 104 of the sidewall of the body 102 a sufficient distance to engage an inner surface of the neck of the portable fuel container into which it is to be received such that the FMD 100 is prevented from falling into the interior of the hollow fuel container body or becoming dislodged due to contact with a fuel nozzle.

In some embodiments, the flange 107 is configured to abut the outer edge of the neck about the opening of a fuel container. This abutment allows the FMD body 102 to insert into the opening of the neck and prevent the FMD 100 from advancing through the neck, i.e., falling into the container. In other embodiments, the flange 107 is configured to engage an inner surface of the container neck and prevent the FMD 100 from falling into the container.

As described above, the body 102 is “perforated” which means it includes numerous perforations or holes, generally designated as perforations 106. The perforations 106 can have any shape, in the illustrated embodiment, perforations 106 are circular-shaped. The shape may be optimized in order to increase/maximize the fractional portion or percentage of the sidewall that can be made open and allow fluid to pass through the FMD 100 and into as well as out of the container.

The plurality of perforations 106 in the body 102 provide a mesh or porous surface for permitting the passage of fluids through the neck of a container to fill or empty the container. As used herein, “perforation open area” means the minimum cross-sectional area of a perforation, measured normal to the direction of extension of the perforation through the wall. The FMD operates by absorbing the heat enough to drop the burning air/fuel mixture below its autoignition temperature at a flame speed between 4-6 meters per second. The perforations 106 in the body 102 define a total open area sufficient to permit normal filling of the container at a high rate of flow without buildup and overflow of fuel from the container. For example the total open area of the perforations 106 in the FMD 100 permit at least nine (9) gallons per minute of gasoline to flow therethrough under common gasoline filling conditions (e.g., atmospheric pressure and ambient temperature).

Generally, perforations 106 according to the present disclosure have an open area between about 1.0 mm² to about 10.0 mm², including 1.0 mm² to about 9.0 mm², 1.0 mm² to about 8.0 mm², 1.0 mm² to about 7.0 mm², 1.0 mm² to about 6.0 mm² and 1.0 mm² to about 5.0 mm². In some embodiments, the perforations have a largest dimensions between 1.0mm² and 4.0 mm². In yet still further embodiments, the perforations have a largest dimensions between 1.0mm² and 2.4 mm². For example and without limitation, an FMD having multiple different sized perforations may have a first perforations with an open area of about 2.4 mm² and a second perforation with an open area of about 3.2 mm².

In some embodiments, an FMD 100 may have perforations of different sizes on body 102. For example and with reference to FIG. 1B, the body may have perforation of a first size 106a and perforations of a second size 106b. In the illustrated embodiment, both perforations 106a and 106b have a circular shape, with perforations 106b having a larger diameter than perforations 106a. While larger diameter perforations 106b are illustrated at the bottom of the FMD 100 this arrangement is not limiting and perforations 106a may be larger than perforations 106b.

In some embodiments, the perforations 106 are aligned radially with respect to the center axis 125. That is, the cross-section of the open area of each perforation 106 has a normal vector that is substantially parallel to a radius extending from the center axis 125 to the body 102. In other embodiments and as illustrated in FIGS. 1A, 1E and 1F, the perforations 106 have a cross-sectional open area with open area normal vectors parallel to each other. In other words, as seen from the side view of FIG. 1A, all circular perforations 106 appear to be circular shaped. In embodiments, one or more of the perforations 106 may have one or more different shapes than the other ones of the perforations 106. In embodiments, one or more of the perforations 106 may be non-circular in shape, for example, one or more of the perforations 106 may be rectangular shaped, oval shaped, tear drop shaped, triangular shaped, etc.

With particular reference to FIG. 1F, illustrating a cross-sectional view of the FMD 100 about a plane bisecting angle θ of prongs 122a, 122b, the FMD 100 may be considered as having a first half 150 and a second opposing half 152. Each half 150, 152 is substantially identical such that each perforation 106a illustrated on first (top) half 150 is coaxial with a corresponding perforations 106a′ on the second (bottom) half 152. Likewise, in embodiments with varying perforation size, larger perforations 106b on the first (top) half 150 are coaxial with a corresponding perforation 106b′ on the second (bottom) half 152.

In some embodiments and as illustrated in the exemplary embodiment of FIG. 1E, the FMD 100 may include a perforation-less body portion 127 along the length L. The perforation-less body portion 127 may define a substantially flat surface defined by the length L and a width W thereof or the perforation-less body portion 127 may define a substantially curved surface (of similar or different curvature of the rest of the FMD body 102) defined by the length L and an arc length A thereof, such that the perforation-less body portion 127 defines an area along the length L with no perforations, and with the area being defined by the length L and either the arc length A or the width W. In embodiments, the perforation-less body portion 127 extends along an entire length of the FMD 100, whereas in other embodiments, the less body portion 127 extends along less than an entire length of the FMD 100. The perforation-less body portion 127 provides structural rigidity to the FMD 100 and may provide a base for supporting retention members 112, described in greater detail below. In some embodiments, the perforation-less body portion 127 is beneficial for lengthwise mold flow when manufactured by injection molding processes. In some embodiments, the FMD is without internal structure such as ribs that may impede penetration of certain types of fluid distribution nozzles such as gasoline vapor recovery nozzles as some vapor recovery nozzles have a large flange that contacts the top of the neck to ensure capture of vapors.

In some embodiments, the FMD 100 includes at least one cantilevered retention member 112. More specifically, the FMD body 102 has an exterior surface 104 of the sidewall of the body 102 from which one or more cantilevered retention member(s) 112 extend therefrom and configured to prevent removal of the FMD 100 from within the portable fuel container. In some embodiments, the cantilevered retention members 112 are separated between about 120 and about 180-degree intervals on the exterior sidewall 102 and about the perimeter of the FMD 100. Each retention member 112 may include a cantilever or sloped surface extending from the exterior sidewall 102. However, it is to be appreciated that any spaced apart relation of retention members 112 may be employed without departing from the scope of this disclosure. As illustrated in FIG. 1C, the retention member(s) 112 are positioned at a distance D below the annular flange 107. In some embodiments, the distance D is about 2.5 mm (1-inch) below the annular flange 107. In use, the retention members 112 each frictionally engage within the container, below the neck, and are used as a safety feature for preventing accidental or intentional removal of the FMD 100 from the interior of the fuel container. In some embodiments, the retention members 112 are orientated such that the FMD 100 may be installed at any orientation, that is, no particular alignment of the FMD 100 for insertion into a container is needed. In some embodiments, the FMD 100 does not require additional hardware to remain in place at correct location in neck of a container. The retention members 112 are such that is difficult for the end consumer to remove the FMD 100 from the container without significantly damaging the container.

In some embodiments and as illustrated in the exemplary embodiment of FIGS. 1B and 1E, the FMD 100 includes a substantially forked/split end 120. The substantially forked/split end 120 shape of the bottom allows for increased fuel flow by its dispersion of liquid out through the outer surface 104 of the sidewalls defined by the body 102, interior facing sidewalls 124a, 124b and across the bottom wall surface 126. That is, at a distance X from the distal end of the body 102, the body splits into at least two prongs 122a and 122b. The distance X ranges from about 0.5 inch to about 2 inches. In some further embodiments, the distance X is about 1.0 inch. The forked/split end 120 may also contribute to reduced splash back and gas pump shutoffs due to shape of “split end” which has increased fluid flow compared to FMDs without the split end. The split end 120 may also redirect fluid flow towards side perforations 106.

As illustrated in FIG. 1B, each prong 122a, 122b forms from the body 102 at a distance X from the end. In some embodiments, each prong 122a, 122b has an outer sidewall that is substantially continuous with the sidewalls defined by the body 102 which are proximally located relative to the prongs 122a, 122b. Each prong 122a, 122b also has an interior facing sidewall 124a, 124b, respectively, that begin at distance X from the end and diverge at an angle θ, wherein angle θ ranges from about 10 degrees to about 90 degrees. In some embodiments, angle θ may be at least about 15 degrees. In some further embodiments, angle θ is about 20 degrees.

Each interior sidewall 124a, 124b, may include a plurality of perforations 136 configured to provide fluid communication from the interior of the FMD 100 to the exterior (and typically into a container), and vice versa. In some embodiments and as illustrated in FIG. 1E, perforations 136 may have elongated shapes, such the ovular shape illustrated in FIG. 1E. In some embodiments, the perforations 136 are formed from mold pins that are substantially parallel to the center axis 125. Thus, the combination of mold pins entering a sloped surface (due to angle 0) the perforations 136 formed appear to have an elongated shape. In these embodiments, the perforations 136 have an open area that is greater than the open area of perforations 106 on the sidewall 104. The perforations 136 may define channels extending through the FMD 100, from an exterior thereof to the hollow interior thereof, and such channels may have various shapes, such as cylindrical shape channels, conical shape (or frusto-conical shape), etc. In some embodiments, some of the perforations 136 may have a different draft than others of the perforations 136, such that some of the perforations 136 have different shaped channels than the others. For example, some of the perforations 136 may have increased draft than others, such that some define conical shaped channels whereas others define cylindrical shaped channels. In embodiments, the perforations 136 and the perforations 106 may all have the same draft such that they all have the same shape (e.g., they are all conical or cylindrical). In embodiments, at least some of the perforations 106 may have an increased draft or taper than the perforations 136.

In some embodiments and with particular reference to FIGS. 1D and 1E, each prong 122a, 122b, terminates at a substantially planar bottom end 126. While illustrated as being substantially semicircular in shape, the shape of the bottom end 126 is not limiting. The planar bottom end 126 of each prong may include perforations 146 similar to provide fluid communication from the interior of the FMD 100 to the exterior (and typically into a container), and vice versa. The perforations 146 may have a size/shape similar to those of perforation 106a, 106b, 136 or one or more may have one or more different sizes/shapes. In some embodiments, and as illustrated in FIG. 1E, the perforations 146 may have an area that is substantially parallel to the center axis 125. That is, an imaginary vector extending normal from the open area of perforation 146 is substantially parallel with the center axis 125 and may be substantially perpendicular to a vector extending normal from the cross-sectional area of perforations 106.

In some embodiments, the at least two prongs 122a, 122b are substantially the same in area, volume and shape. In some further embodiments, the prongs 122a, 122b are mirror images of each other about central line 125.

The FMD 100 is inserted into the neck of the container, such that the FMD 100 is suspended in the interior volume of the hollow tank body providing a flame mitigation property to the total container assembly. In certain embodiments, it may be desirable for the FMD 100 be permanently attached (i.e., non-removable) to the container by, for example, bonding or welding the FMD 100 to the container neck 103. The attachment of the FMD 100 to the neck of the container is generally a sealed connection, meaning that all fluid exchange between the interior and exterior of the container takes place through the FMD 100 (and the perforations 106).

In some embodiments, the FMD 100 is assembled and sealed to the inside surface of the neck of the container by way of a frictional fit. Here, the interior surface of the neck may have a decreasing inner dimension (e.g. diameter) towards the hollow tank body. In these embodiments, the flange 107 abuts the inner surface at a point which the inner diameter of neck matches the outer diameter OD of the flange 107. The flange 107 and/or portions of the hollow body 102 are bonded to the interior surface of the container neck. Bonding may include but is not limited to welding, melting, heat staking, adhesively sealing.

The FMD 100 may be fabricated by a molding process. In particular, the FMD 100 may be constructed from a mold having two shells and a core. In some embodiments, each mold provides a piece similar to FIG. 1H, a view taken along line B of FIG. G. That is, the FMD 100 comprises two substantially identical molded pieces joined together along a plane bisecting the length of the FMD.

In some embodiments, the interior surface 160 of the FMD 100 includes a texture 161. The texture 161 may be configured to increase the average roughness of the surface and may reduce splashback and shutoffs at gas nozzles with vapory recovery flanges. In some further embodiments, the texture 161 of the interior surface 106 includes a texturing at 200-500 microinches average roughness. In embodiments, the texture 161 is applied via sand blasting. While the texture 161 is illustrated in FIG. 1F as just being located on a portion of the interior surface 160, it may be provided on substantially all of the interior surface 160 or along certain segments 162 of the interior surface 160 that extend along the length L and correspond with the perforation-less body portion(s) 127. In embodiments, the texture 161 is provided on portions of the interior surface 160 situated in-between all or some of the plurality of perforations 106.

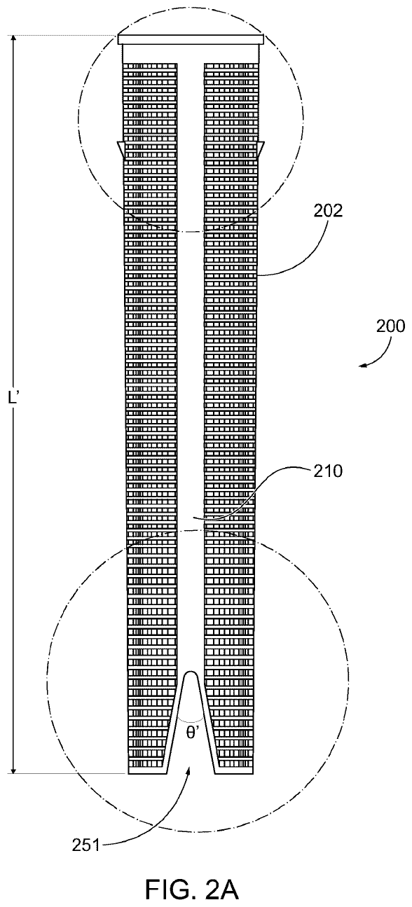

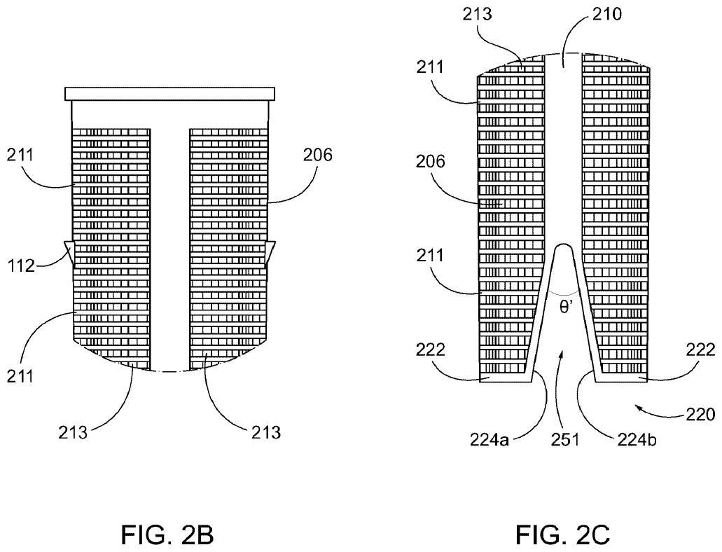

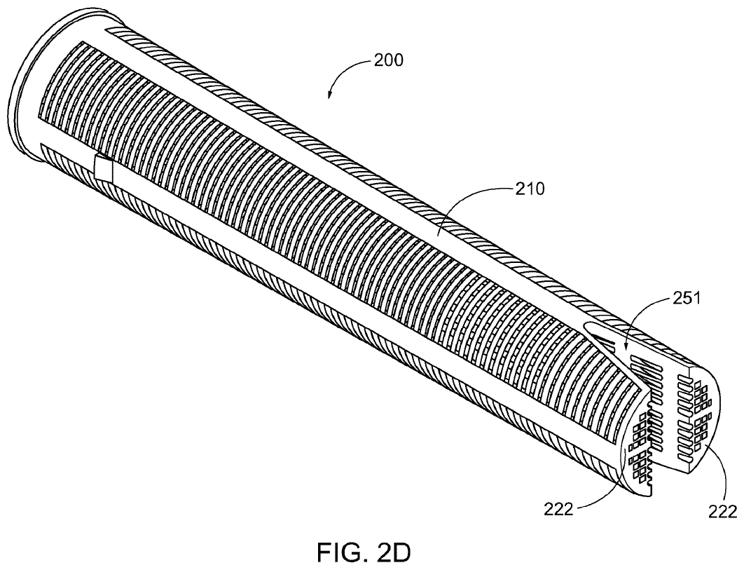

FIGS. 2A-2D illustrates another exemplary flame mitigation device 200 in accordance with the present disclosure. FIG. 2A illustrates a side plan view wherein FIGS. 2B and 2C illustrate detailed views of the top and bottom portions of the FMD 200, respectively. FIG. 2D illustrates a perspective view of FMD 200. The FMD 200 includes a generally cylindrically hollow body 202 having a length L′, similar to body 102 and best understood with respect thereto. The FMD 200 also includes a top flange 207 similar to flange 107 and best understood with respect thereto.

The body 202 is configured with a plurality of perforations 206 that allow fluid communication from the interior of the hollow body to the exterior of the hollow body and vice versa. That is, fluid flow is possible through the FMD 200 through the perforations 206. Here, perforations 206 are defined by open areas (“voids”) between adjacent annular ribs 211 and longitudinal ribs 213. That is, the body 202 is defined by substantially annular ribs 211 aligned vertically along a length L′ and longitudinal ribs 213 around the perimeter/circumference of the hollow body 202. The annular ribs 211 and longitudinal ribs 213 provide a “lattice” structure, i.e. a frame of crossed ribs. In some embodiments, annular ribs 211 may extend continuously around the perimeter of the hollow body 202. In other embodiments and as illustrated, annular ribs 211 may extend partly around the perimeter of the hollow body 202. That is, they may connect to a longitudinal body panel 210 similar to perforation-less body portion 127 defining an area along the length with no perforations. In the illustrated embodiment of FIG. 2D, the FMD 200 includes four equally spaced apart longitudinal body panels 210. The vertical spacing between adjacent annular ribs 211 may be constant along the length L′ and/or may vary. In the exemplary embodiment of FIGS. 2A-2D, the annular ribs 211 have a first spacing about the top portion of the FMD 200 and have a second spacing about the bottom portion of the FMD 200 (toward the split end). The second spacing may be greater such that the perforations 206 have a greater open area for fluid flow. While the lattice structure of the ribs 211 and 213 are shown as creating substantially rectangular shaped perforations 206, the perforation shape is not limiting. For example, the longitudinal and annular ribs may be oriented with respect to each other such that other perforation shapes are created including but not limited to triangular shaped perforations, parallelogram shaped perforations and the like.

In some embodiments, the ribbed lattice design of the exemplary embodiments of FIGS. 2A-2D allows for mold tooling to have lower stress concentrations. The ribbed lattice design may also experience less problems with plastic flash, i.e., plastic that remains on the part in unwanted areas after being ejected from the mold. The mold tooling has continuous rings and flanges instead of individual pins, and may require less preventive maintenance and repairs.

The FMD 200 includes a substantially forked, split end 220 similar to split end 120 and best understood with reference thereto. That is, at a distance X from the distal end of the body 202, the body splits into at least two prongs, each designated generally by reference numeral 222. Each prong 222 also has an interior facing sidewall 224a, 224b, similar to sidewalls 124a, 124b, that begin at distance X from the end and diverge at an angle θ′, such that a substantially V-shaped gap 251 is defined between opposing interior facing sidewalls 224a, 224b of each prong 222, wherein the angle θ′ ranges from about 10 degrees to about 90 degrees. In some embodiments, angle θ may be at least about 15 degrees. In some further embodiments, angle θ′ is about 20 degrees. Like the split end 120 of FMD 100, the substantially forked/split end 220 shape of the bottom allows for increased fuel flow by its dispersion of liquid out of the sidewall of the body 202.

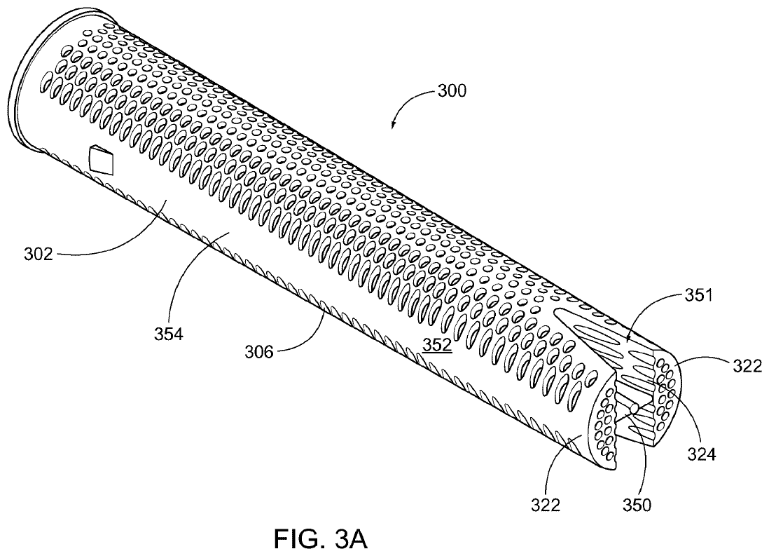

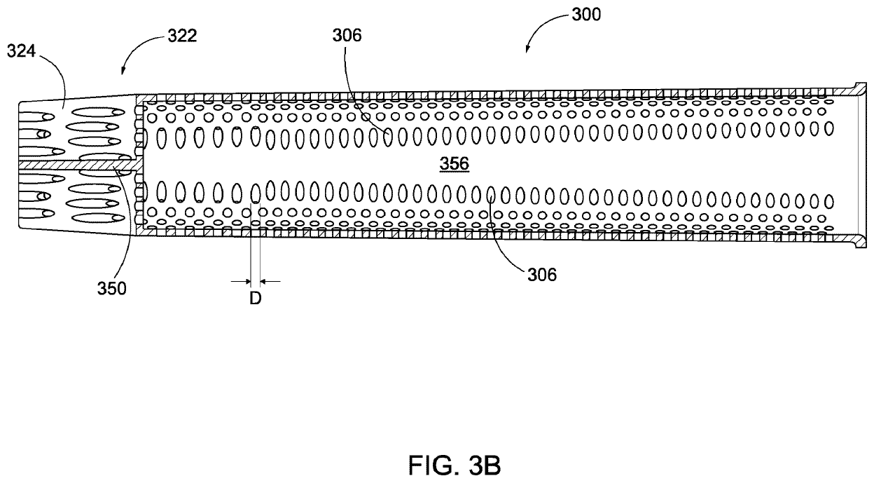

FIGS. 3A and 3B illustrate another exemplary embodiment of a FMD 300 similar in many respects to FMDs 100 and 200 and best understood with reference thereto. FIG. 3A illustrates a perspective view of FMD 300 while FIG. 3B illustrates a cross-sectional view taken along a plane bisecting the angle of the split end prongs. In the FMD 300, a rib 350 is positioned between each prong 322. That is, the rib 350 spans the substantially V-shaped gap 351 between opposing inner sidewalls 324 of each prong 322. The rib 350 may provide additional structural support for the FMD 300 and/or may improve the moldability of the flame mitigation device 300.

In some embodiments and as illustrated in the embodiment of FIGS. 3A-3B, perforations 306 are formed within the body 302 similar in some aspects to perforations 106 of FMD 100. In some embodiments, all or at least some of the perforations 306 are cylindrical in shape. In other embodiments, as shown in FIG. 3B, at least some of the perforations 306 have increased draft, i.e., one or more of the perforations 306 may be tapered or cone shape, which may improve moldability of the device 300. In particular, a draft of the perforations 306 may increase from the center about the plane bisecting the angle of the split end prongs to the sides away from the center plane. In some embodiments, the additional draft provides for perforations with a variable diameter D′ that either decreases or increases through the thickness of the body 302. In some further embodiments, the variable D′ diameter of the perforations 306 decreases from an outer surface 352 (of a sidewall 354 of the body 302) to the interior surface 356 (of the sidewall 354), such that the variable D′ diameter of the perforations 306 decreases through the thickness of the body 302.

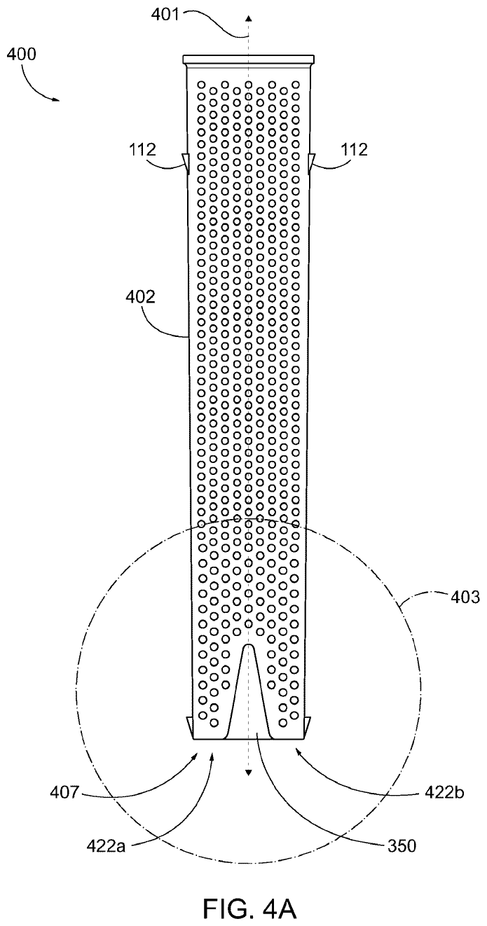

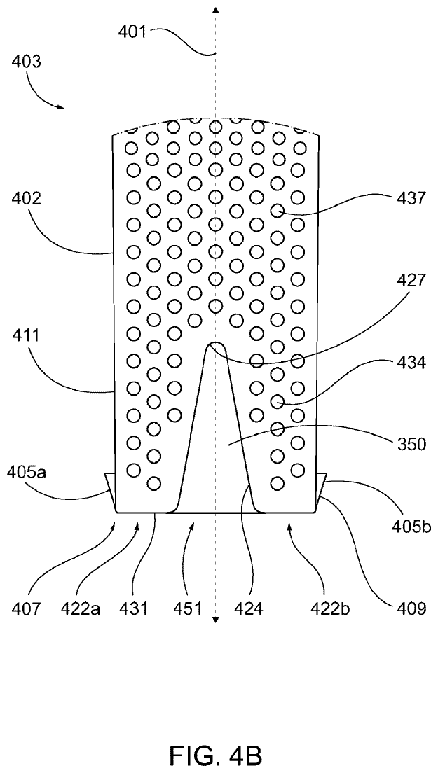

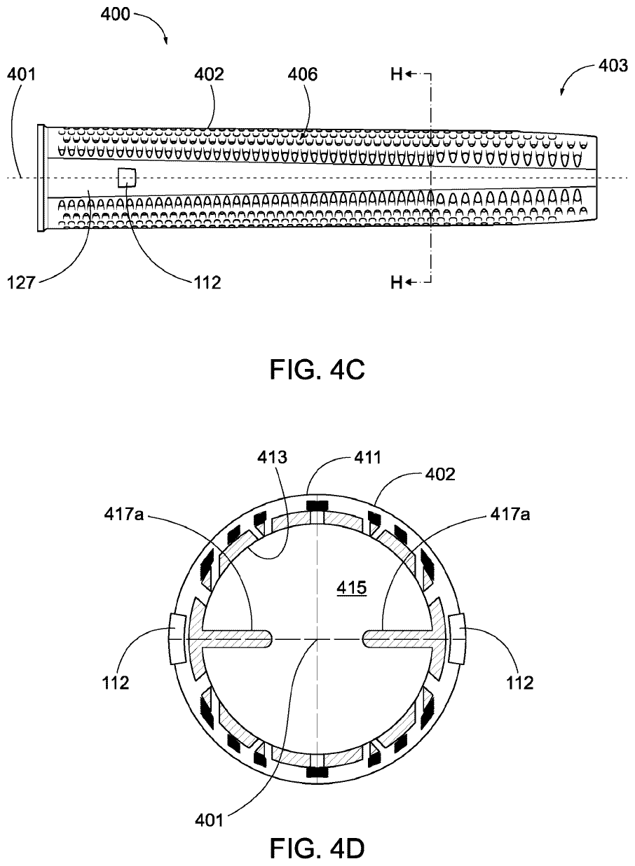

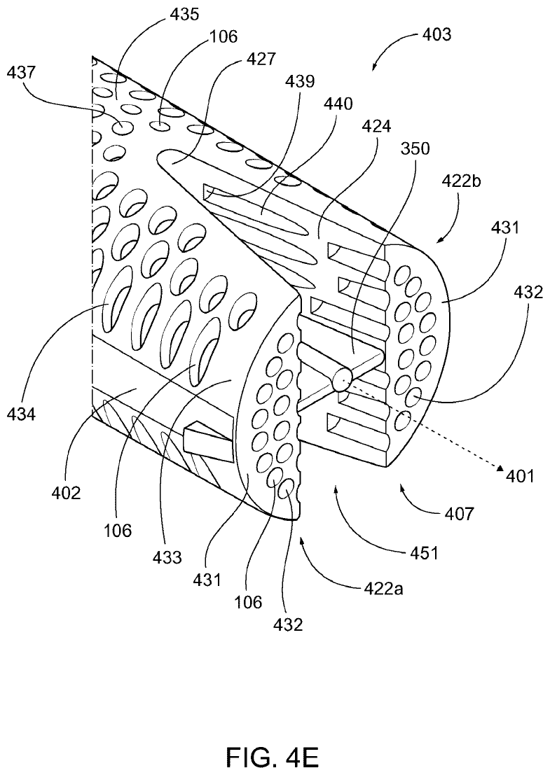

FIGS. 4A to 4E illustrate another exemplary embodiment of a FMD 400 similar in many respects to FMDs 100, 200, 300 and best understood with reference thereto. The FMD 400 includes a body 402 that extends along a central axis 401 and includes a distal section 403 at which prongs 422a, 422b are provided. As mentioned, a plurality of perforations 406 are formed through the body 401 that allow fluid communication from an inner surface of the sidewall to the outer surface of the sidewall. FIG. 4B illustrates a close up side view of the distal section 403. As shown, a V-shaped gap 451 is defined between opposing inner sidewalls 424 of each prong 422a,422b. In the illustrated embodiment, tabs 405a, 405b are provided on the distal section 403 of the body 402, and extend radially outward from an exterior surface 411 (or outer surface 411) of the body 402 relative to the central axis 401. The tabs 405a, 405b include a first tab 405a extending from the outer surface 411 of the first prong 422a and a second tab 405b extending from the outer surface 411 of the second prong 422b. In the illustrated embodiment, the tabs 405a, 405b are triangular in shape. Also in the illustrated embodiment, the tabs 405a, 405b are provided at a distal end 407 of the body 402, such that a sloped surface 409 of the tabs 405a, 405b the extends from (or joins) the distal end 407 of the body 402; however, the tabs 405a, 405b may be positioned more proximally (along the central axis 401), relative to the distal end 407 of the body 402, such that at least a small gap exists between a distal most portion of a surface (e.g., the sloped surface 409) of the tabs 405a, 405b and the distal end 407 of the body 402. In other embodiments, either or both of the tabs 405a, 405b may have different shapes other than triangles. By including the tabs 405a, 405b, it is possible to inhibit the FMDs 400 from nesting within each other, for example when the FMDs 400 are in a vibratory bowl during automated assembly as the FMDs 400 would otherwise tend to nest or stack within each other during assembly which would prevent them from properly queuing. Accordingly, the tabs 405a, 405b inhibit nesting of the FMDs 400.

FIG. 4C illustrates another side view of the FMD 400 of FIG. 4A when rotated ninety degrees about the central axis 401, and FIG. 4D is a cross-sectional view of the FMD 400 along section line H-H in FIG. 4C. As shown, the body 402 includes the exterior surface 411 and an interior surface 413, with the interior surface 413 defining an interior hollow space 415 within the body 402. In the illustrated embodiment, a pair of ribs 417a, 417b are provided within the interior hollow space 415 within the body 402. As shown, the ribs 417a, 417b are provided on the body 402 and extend inwardly from the interior surface 413 thereof. Here, the ribs 417a, 417b each extend towards the central axis 401 and the ribs 417a, 417b are the positioned at locations of interior surface 413 that correspond with the perforation-less body portion 127 and the cantilevered retention members 112. However, more or less than a pair of the ribs 417a, 417b may be provided; and, regardless of how many are provided, they may be provided at different locations on the interior surface 413 (e.g., 4 interior ribs may be provided equidistantly about the interior surface 413 such that they are spaced at ninety-degree intervals), and any one or more of the ribs may extend into the hollow space 415 at a different orientation than what is shown. By including the ribs 417a, 417b, blacksplash may be minimized or prevented by breaking up the flow before the flow hits/contacts the distal end 407 of FMD 400 and splashes back, and helps send fuel out through the side holes (i.e., the proximal side openings 437 and/or distal side openings 434 detailed below) so that the distal end openings 432 are not overwhelmed/inundated with flow.

FIG. 4E illustrates a perspective view of the distal end 403 of the FMD 400. In the illustrated embodiment, the body 402 extends along the central axis 401 and includes proximal sidewalls 435 and distal sidewalls 433, with the proximal sidewalls 435 being positioned further from the distal end 407 than the distal sidewalls 433 when evaluated along the center axis 401 and with the distal sidewalls 433 corresponding with the prongs 422a,422b. Here, the body 402 also includes a distal wall 431 positioned at the distal end 407 of the prongs 422a,422b, the opposing inner sidewalls 424 of each prong 422a,422b, and a bridge portion 427 adjoining and extending between the opposing inner sidewalls 424. In this manner, each of the prongs 422a,422b is defined by its corresponding distal sidewalls 433 and corresponding inner sidewalls 424. Also do to this construction, the distal end 407 of the body 402 is closed but for the presence of the plurality of openings and perforations provided through the distal walls 431, the distal sidewalls 433, and the inner sidewalls 424. In embodiments, one or more openings may be provided through the bridge portion 427 and, where such openings are provided through the bridge portion 427, such openings may be substantially cylindrical and/or some of them may have a draft/taper such that they are cone shaped as described herein.

In the illustrated embodiment, the FMD 400 includes distal end openings 432 provided in the distal wall 431, distal side openings 434 at are provided through the distal sidewalls 433 of the prongs 422a,422b, distal inner side perforations 439 provided through the corresponding inner sidewalls 424 of the prongs 422a,422b, and proximal side openings 437 provided through proximal sidewalls 435 of the body 402. The distal inner side perforations 439 may be provided similarly as described with reference to the perforations 136 detailed above. In the illustrated embodiment, the distal inner side perforations 439 are oriented in a similar/same direction as the distal end openings 432, such that the distal end openings 432 and the distal inner side perforations 439 all face and open towards the distal end 407. However, one or more of the distal inner side perforations 439 may be oriented to open and face in the same or similar orientation as the inner sidewalls 424. Also in the illustrated embodiment, a scoop portion 440 is formed on the corresponding inner sidewall 424 proximate to each of the distal inner side perforations 439, such that one of the scoop portions 440 leads into each of the distal inner side perforations 439, towards regions of the interior hollow space 415 defined within each of the prongs 422a,422b.

The distal end openings 432, the distal side openings 434, and the distal inner side perforations 439 are all in fluid communication with regions of the interior hollow space 415 defined within each of the prongs 422a,422b of the body 402. Here, the distal end openings 432 each extend in a direction substantially parallel to the center axis 401; however, one or more of the distal end openings 432 may extend in a different orientation. Similarly, the distal inner side perforations 439 (and their corresponding scoop portions 440) each extend in a direction substantially parallel to the center axis 401; however, one or more of the distal inner side perforations 439 (and/or their corresponding scoop portions 440) may extend in a different orientation.

In embodiments, some of the plurality of openings and/or perforations 432,434,437,439 may have different drafts (or tapers) than others of the plurality of openings and/or perforations 432,434,437,439. For example, the distal end openings 432 and/or the distal inner side perforations 439 may have a different (e.g., lesser) draft or taper than the other ones of the plurality of openings 434,437. In embodiments, the distal end openings 432 may have a different (e.g., lesser or greater) draft or taper than the distal inner side perforations 439, or at least some of the distal end openings 432 and the distal inner side perforations 439 may have the same draft or taper. In embodiments, the distal end openings 432 and the distal inner side perforations 439 are cylindrical shaped openings and do not have a draft or taper. In embodiments, the distal side openings 434, the distal inner side perforations 439, and/or the proximal side openings 437 may all have the same draft or taper (e.g., a three degree draft), or any one or more of them may have a different draft or taper; or, in embodiments, none of the distal side openings 434, the distal inner side perforations 439, and the proximal side openings 437 have a draft or taper, such that they are all generally cylindrical in shape. In embodiments, the distal side openings 434 and the proximal side openings 437 may all have the same draft or taper (e.g., a three degree draft such that they are cone shape), or any one or more of them may have a different draft or taper, with the distal end openings 432 and the distal inner side perforations 439 having no draft or taper (i.e., the distal end openings 432 and the distal inner side perforations 439 are substantially cylindrical in shape).

In embodiments, the size of the distal side openings 434 and the proximal side openings 437 increases, from the interior surface 413 towards the exterior surface 411 (i.e., a diameter of the distal side openings 434 and the proximal side openings 437 is slightly smaller on the interior surface 413 than on the exterior surface 411), such that the distal side openings 434 and the proximal side openings 437 define generally cone shaped or frusto-conical shaped openings or channels and, in such embodiments, the distal end openings 432 and the distal inner side perforations 439 may have no draft or taper, such that the distal end openings 432 and the distal inner side perforations 439 define generally cylindrical shaped openings or channels. For example, the distal side openings 434 and the proximal side openings 437 may include a three degree draft or taper such that they are generally conical or frusto-conical in shape, and the distal end openings 432 and the distal inner side perforations 439 may have a lesser draft or taper (e.g., a two degree, one degree, or zero degree draft) such that they are less conically shaped or even cylindrical in shape. Accordingly, in such embodiments, the distal side openings 434 and the proximal side openings 437 have an increased draft or taper as compared to the distal end openings 432 and the distal inner side perforations 439.

The singular forms “a,” “an,” and “the” include plural referents unless the context clearly dictates otherwise.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

As used herein, the terms “generally” and “substantially” are intended to encompass structural or numeral modification which do not significantly affect the purpose of the element or number modified by such term.

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

In this document, relational terms such as first and second, top and bottom, greater than and less than, and the like may be used solely to distinguish one entity or action from another entity or action without necessarily requiring or implying any actual such relationship or order between such entities or actions.

To aid the Patent Office and any readers of this application and any resulting patent in interpreting the claims appended hereto, applicants do not intend any of the appended claims or claim elements to invoke 35 U.S.C. 112 (f) unless the words “means for” or “step for” are explicitly used in the particular claim.

What is claimed is:

1. A flame mitigation device comprising:
a rigid hollow body extending along a center axis thereof and having a plurality of perforations configured to provide fluid communication therethrough,
the body having a split end comprising at least two prongs that have interior facing prong sidewalls diverging at an angle.

2. The flame mitigation device according to claim 1, wherein the flame mitigation device is configured to absorb enough heat to drop the burning air/fuel mixture below its autoignition temperature at a flame speed between 4-6 meters per second.

3. The flame mitigation device according to claim 1, further comprising at least one perforation-less body portion defining an area along a length of the flame mitigation device.

4. The flame mitigation device according to claim 1, further comprising one or more cantilevered retention members extending from an exterior sidewall of the body configured to prevent removal of the flame mitigation device from a portable fuel container.

5. The flame mitigation device according to claim 1, wherein the perforations comprise perforations of a first size and perforations of a second size.

6. The flame mitigation device according to claim 1, further comprising a planar bottom end of each of the at least two prongs.

7. The flame mitigation device according to claim 6, further comprising one or more bottom perforations located on the planar bottom end of each of the at least two prongs, the one or more bottom perforations configured to provide fluid communication from an interior of the flame mitigation device to an exterior thereof.

8. The flame mitigation device according to claim 1, wherein an open area of each perforation has a normal vector that is substantially parallel to a radius extending from the center axis of the body.

9. The flame mitigation device according to claim 1, wherein an open area of each perforation has a normal vector that, and the normal vectors associated with each of the portions are parallel to each other.

10. The flame mitigation device according to claim 1, further comprising a prong rib extending between the interior facing prong sidewalls.

11. The flame mitigation device according to claim 1, wherein perforations have a variable diameter through a thickness of the body.

12. The flame mitigation device according to claim 11, wherein the variable diameter of the perforations decrease from an outer surface of the body to an interior surface of the body.

13. The flame mitigation device according to claim 1, wherein an interior surface of the FMD includes a surface texture.

14. The flame mitigation device according to claim 13, wherein the surface texture is about 200 to about 500 microinches average roughness.

15. The flame mitigation device according to claim 1, further comprising a pair of tabs extending from an outer surface of the body at the at least two prongs, the pair of tabs including a first tab extending form the outer surface of a first prong of the at least two prongs and a second tab extending form the outer surface of a second prong of the at least two prongs.

16. The flame mitigation device according to claim 1, wherein the body includes a sidewalls and a distal wall at one end of the body, and the plurality of perforations comprises distal openings formed in the distal wall of the body, the distal opening having different draft than the other ones of the plurality of openings formed through the sidewalls.
